(19) United States
(12) Patent Application Publication
(10) Pub. No.: US 2012/0103733 A1
(43) Pub. Date: May 3, 2012

(54) ELECTRIC DISC BRAKE APPARATUS

(76) Inventor: Kazuhiro Sekiguchi, Tokyo (JP)

(21) Appl. No.: 13/320,114

(22) PCT Filed: Mar. 23, 2010
(86) PCT No.: PCT/JP2010/054963

§ 371 Date: Dec. 16, 2011

(30) Foreign Application Priority Data
May 13, 2009 (JP) 2009-116908

(51) Int. Cl. B60T 1/06; F16D 65/18; F16D 55/226

(52) U.S. Cl. 188/72.1

(57) ABSTRACT

In an electric disc brake apparatus, a rotating shaft which is rotated and driven by an electric motor and forms an input part of a force-multiplication mechanism is provided with a flange part. Thrust bearing is arranged between a sensor and an inner side surface of the flange part. The thrust bearing and the flange part are accommodated inside a case unit. The case unit includes an inner case, and an outer case coupled with the inner case in an inseparable state. An elastic member is formed between an inner side surface of the outer case and an outer side surface of the flange part. The elastic member urges the thrust bearing to a side of the inner case in which the sensor is installed.

### TECHNICAL FIELD

This invention is related to an electric disc brake for braking a vehicle using an electric motor as a driving source.

### BACKGROUND ART

An electric disc brake using an electric motor as a driving source does not require piping necessary for a hydraulic disc brake. As a result, the electric disc brake becomes easier to manufacture than the hydraulic disc brake and the manufacturing cost of the electric disc brake is reduced. Also, in the electric disc brake, the used brake fluid is not generated as in the hydraulic disc brake, so that an environmental load is reduced. Further, in the electric disc brake, there is no movement of the brake fluid, so that responsiveness is improved. Thus, many advantages are expected in the electric disc brake. In the electric disc brake, it is necessary to convert rotational motion of the electric motor into linear motion while increasing a force of the rotational motion in order to tightly push a pair of pads on both side surfaces of a rotor. In view of such circumstances, an electric disc brake having a reducer of a gear type etc. and a force-multiplication mechanism of a ball lamp type or a cam roller type is disclosed in Patent Literatures 1 to 7. In addition, in structures described in Patent Literatures 4, 5 and 7 of them, a brake at the time of travel is put by a hydraulic type and a brake at the time of parking is put by an electric type, respectively.

FIG. 9 shows one example of a structure described in Patent Literature 6 of them. Like a general hydraulic disc brake, in this electric disc brake, an inner pad 2 and an outer pad 3 are installed in a state of pinching a rotor 1 rotating with a wheel so as to enable axial displacement of this rotor 1. For this purpose, a support member (not shown) is supported (fixed in a knuckle constructing a suspension device) in a vehicle body in a state adjacent to this rotor 1. Both the inner and outer pads 2, 3 are supported in the support member so as to enable axial displacement in a state of pinching the rotor 1 from both axial sides (the outer side refers to the outside of a width direction of this vehicle body in a state of being incorporated into the vehicle body and the inner side refers to the center side likewise, respectively. Also, the axial direction refers to an axial direction of the rotor 1 unless otherwise noted. The same applies to all of the present description and the claims).

Also, a caliper 4 is incorporated into this support member so as to enable axial displacement. This caliper 4 is provided with a caliper claw 5 in the end of the outer side and cylinder space 6 inside the inner side portion, respectively. The caliper claw 5 is opposed to an outer side surface of the outer pad 3 and the inner pad 2 is pressed toward an inner side surface of the rotor 1 by a thrust generation mechanism 7 provided inside the cylinder space 6. When the inner pad 2 is pushed on the inner side surface of the rotor 1 by the thrust generation mechanism 7 at the time of braking, the caliper 4 is displaced to the inner side and the caliper claw 5 pushes the outer pad 3 on an outer side surface of the rotor 1. As a result, this rotor 1 is tightly pinched from both axial sides and a brake is put. The above configuration and action are similar to those of the hydraulic disc brake widely implemented.

For the electric disc brake, a gear type reducer 10, the thrust generation mechanism 7 and a piston member 11 are provided between an inner side surface of the inner pad 2 and an output shaft 9 of an electric motor 8 in order to push the inner pad 2 on the inner side surface of the rotor 1 using the electric motor 8 as a driving source. A rotational force in which torque is increased while being decelerated by this reducer 10 is transmitted to a driving side rotor 13 constructing a force-multiplication mechanism of a ball lamp type through a feed screw engaging part 12, and the driving side rotor 13 rotates. The driving side rotor 13 parallel moves to the outer side by a function of the feed screw engaging part 12 until gaps between both the inner and outer pads 2, 3 and a side surface of the rotor 1 are eliminated. On the other hand, after the gaps are eliminated and the function of this feed screw engaging part 12 stops, the driving side rotor 13 rotates. Then, based on engagement (rolling contact) among plural driving side lamp grooves 14, 14 provided in an outer side surface of the driving side rotor 13, plural driven side lamp grooves 16, 16 provided in an inner side surface of a driven side stator 15 attached to an inner side surface of the piston member 11, and plural balls 17 pinched between both these lamp grooves 14, 16, a distance between the driving side rotor 13 and the driven side stator 15 is extended by a great force, with the result that an outer side surface of the piston member 11 is tightly pushed on the inner side surface of the inner pad 2.

For example, in order to apply a proper braking force to a wheel based on a pedal force applied to a brake pedal by the electric disc brake acting and constructed as described above, it is necessary to know a thrust force applied to both the inner and outer pads 2, 3 by the thrust generation mechanism 7. A structure of providing a part of a caliper (the inside of a piston part or a caliper claw) with an axial force sensor such as a strain sensor, for example, a piezoelectric element is disclosed in Patent Literatures 8 and 9.

However, in the structure for measuring a thrust force disclosed in Patent Literatures 8 and 9, the axial force sensor is incorporated into the caliper separately from a component of the thrust generation mechanism, so that incorporation efficiency is low and an increase in a manufacturing cost of the electric disc brake is caused. Also, arrangement of a harness for extracting a measured signal of this axial force sensor becomes complicated in the structure of incorporating the axial force sensor into the caliper claw as described in Patent Literature 8. Further, since prestress is not applied to the axial force sensor, it is disadvantageous to ensure measurement accuracy of this axial force sensor. Concretely, a relation between an axial force and a measured signal tends to become nonlinear and also it is difficult to ensure stability of the measured signal in the case where the axial force is small and it is difficult to ensure accuracy in the case of obtaining the axial force from the measured signal.

### CITATION LIST

### Patent Literature

Patent Literature 1: JP-A-2000-291702
Patent Literature 2: JP-A-2001-173691
Patent Literature 3: JP-A-2001-311443
Patent Literature 4: JP-A-2003-014015
Patent Literature 5: JP-A-2003-065366
Patent Literature 6: JP-A-2004-169729
Patent Literature 7: JP-A-2008-045703
Patent Literature 8: JP-A-2004-183694
Patent Literature 9: JP-A-2005-090539

### SUMMARY OF INVENTION

One or more embodiments of the invention provide a structure in which an electric disc brake capable of stably obtaining a desired braking force can be obtained at low cost by being constructed so that a measuring unit including a thrust generation mechanism and a sensor in which prestress is applied to its own sensor or a measured part is easily incorporated into a caliper.

According to one or more embodiments of the invention, an electric disc brake apparatus includes a rotor rotating with a wheel, a support member supported in a vehicle body, an outer pad which is arranged in an outer side of an axial direction of the rotor and is supported in the support member so as to enable axial displacement, an inner pad which is arranged in an inner side of the axial direction and is supported in the support member so as to enable the axial displacement, a caliper including a caliper claw formed in an outer side end of the axial direction and opposed to an outer side surface of the outer pad, and accommodating space formed inside an inner side portion of the axial direction, the caliper being supported so as to enable axial displacement with respect to the support member, and an actuator which is arranged inside the accommodating space and presses the inner pad toward an inner side surface of the rotor. The actuator includes an electric motor, a force-multiplication mechanism for converting a rotational driving force of the electric motor into an axial thrust force and transmitting the force to the inner pad, and a sensor for measuring a push force applied from the force-multiplication mechanism to this inner pad. A rotating shaft which is rotated and driven by the electric motor and forms an input part of the force-multiplication mechanism is provided with an outward flange-shaped flange part. Thrust bearings are formed between the sensor and an inner side surface of the flange part. The thrust bearings and the flange part are accommodated inside a case unit. The case unit includes an inner case formed in a portion including an inner side from the thrust bearings, and an outer case which is formed in a portion including an outer side from the flange part and is coupled with this inner case in an inseparable state. An elastic member is formed between an inner side surface of the outer case and an outer side surface of the flange part. The elastic member urges the thrust bearings to a side of the inner case in which the sensor is installed.

In the structure described above, the case unit may be divided into two pieces in the axial direction. One piece of the divided case unit positioned in an inner side may be the inner case. The other piece of the divided case unit positioned in an outer side may be the outer case. The sensor, the thrust bearings, the flange part and the elastic member may be accommodated inside the case unit in a state of urging the sensor in the axial direction by the elastic member so that the thrust bearings are arranged in an outer side of the sensor and the flange part is arranged in an outer side of the thrust bearings and the elastic member is arranged in an outer side of the flange part. The outer case may be provided with a locking piece elastically projecting radially outwardly from an outer peripheral surface of a radial direction of the outer case. An inner peripheral surface of the radial direction of the accommodating space may be provided with a locking recess. The locking piece may engage with the locking recess, and the sensor, the thrust bearings, the flange part and the elastic member may be held inside the accommodating space through the case unit.

Also, in the structure described above, the elastic member having an axial elastic force may be attached to an outer side surface of the flange part. The sensor, the thrust bearings and the flange part may be accommodated inside the case unit in a state of elastically compressing the elastic member in the axial direction.

Also, in the structure described above, the case, arranged in a side opposite to the sensor with the flange part pinched, of the inner case and the outer case may be provided with an elastic piece as the elastic member. The elastic piece may urge the flange part toward the sensor.

Also, in the structure described above, the inner case may include a bottom plate part having a central hole into which the rotating shaft is rotatably inserted, and a cylindrical part folded in a direction near to the outer case from a radial peripheral edge of the bottom plate part. The outer case may include a bottom plate part having a central hole into which the rotating shaft is rotatably inserted, and a cylindrical part folded in a direction near to the inner case from a radial peripheral edge of the bottom plate part. The cylindrical part of the outer case may be externally fitted to the cylindrical part of the inner case. A distal edge of an inner side of the cylindrical part of the outer case may be provided with a protrusion piece folded radially inwardly. An engaging hole may be formed in a part of the cylindrical part of the inner case. The protrusion piece may enter the engaging hole, and the inner case and the outer case may be coupled in an inseparable state so as to enable axial relative displacement.

Also, in the structure described above, the outer case may be made of a case body including a holding recess which rotatably accommodates the flange part and is opened to an outer side. The inner case may be made of a snap ring locked in an opening side end of the holding recess. The thrust bearings, the flange part and the elastic member may be accommodated inside the case unit made of the case body and the snap ring in a state of urging the sensor in the axial direction by the elastic member so that the flange part is arranged in an outer side of the thrust bearings and the elastic member is arranged in an outer side of the flange part. The sensor may be incorporated into the case body. The case body may be coupled and fixed to an inner side end of the caliper.

Also, in the structure described above, the sensor may be made of a strain sensor which is attached to a surface of the case body and measures an urging force by the elastic member based on strain of the case body.

Also, in the structure described above, the sensor may be pinched between the thrust rolling bearings and the case body.

According to the electric disc brake of the embodiments of the invention configured as described above, a measuring unit including a thrust generation mechanism and the sensor in which prestress is applied to its own sensor or a measured part is easily incorporated into the caliper. As a result, the electric disc brake capable of stably obtaining a desired braking force can be obtained at low cost.

Other features and effects will be apparent from the mention of the embodiments and the appended claims.

### BRIEF DESCRIPTION OF DRAWINGS

FIG. 1 is a sectional view showing a first embodiment of the invention in which the lower part corresponds to a sectional portion of a-o-a of FIG. 2 and the right end and the upper part correspond to a sectional portion of b-o-b of FIG. 2, respectively.

FIG. 2 is a sectional view taken on line c-c of FIG. 1.

FIG. 3A is a sectional view showing a unit of combining a force-multiplication mechanism and an axial force sensor in a state of incorporating the unit into a caliper, and FIG. 3B is a sectional view showing the unit of combining the force-multiplication mechanism and the axial force sensor in a state before incorporating the unit into the caliper.

FIG. 4 is a view corresponding to d part of FIG. 3A, showing a second embodiment of the invention.

FIG. 5 is a sectional view of a caliper portion, showing a third embodiment of the invention.

FIG. 6 is a sectional view taken on line e-e of FIG. 5.

FIG. 7 is an exploded perspective view of the caliper portion of the third embodiment of the invention.

FIG. 8 is a view corresponding to f part of FIG. 5, showing a fourth embodiment of the invention.

FIG. 9 is a sectional view of a caliper portion, showing one example of a conventional structure.

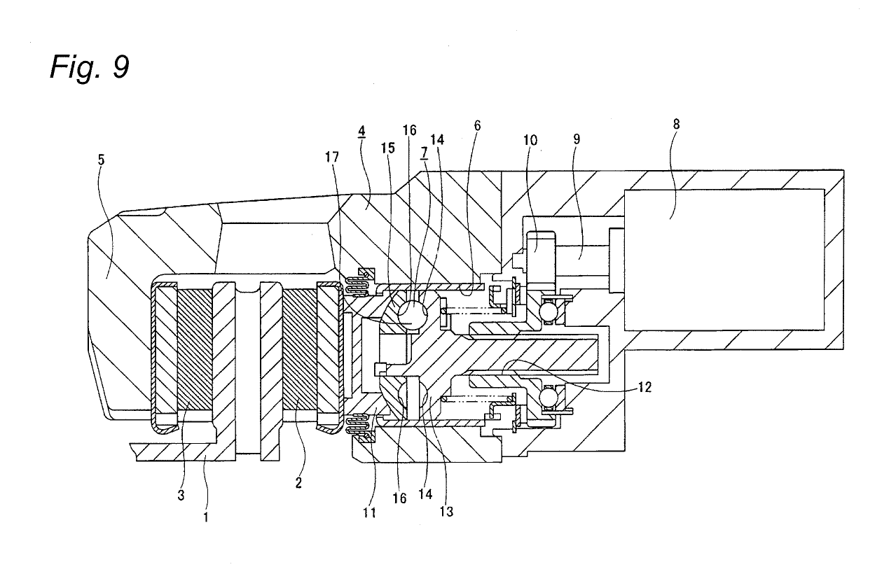

### DESCRIPTION OF EMBODIMENTS

Embodiments of the invention will be described with reference to the drawings.

### First Embodiment

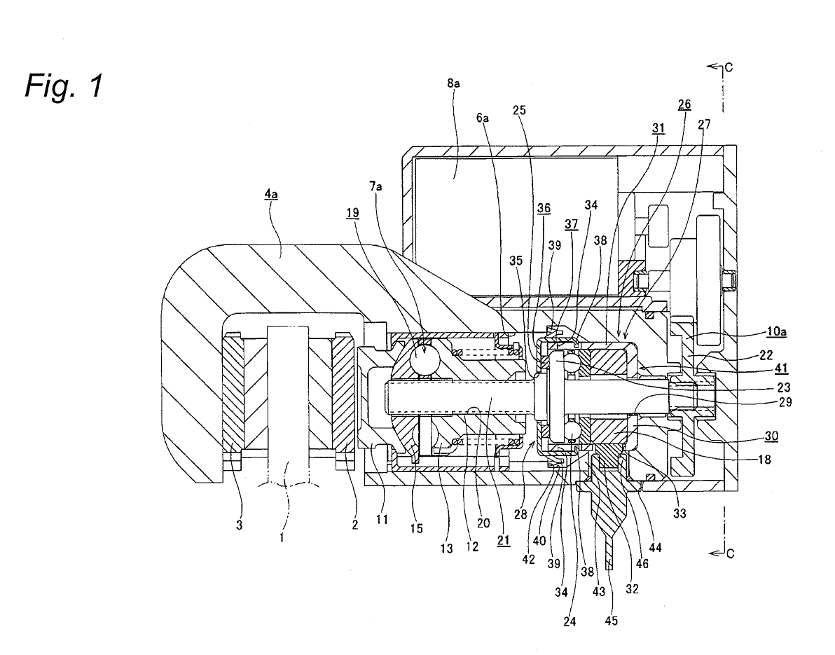

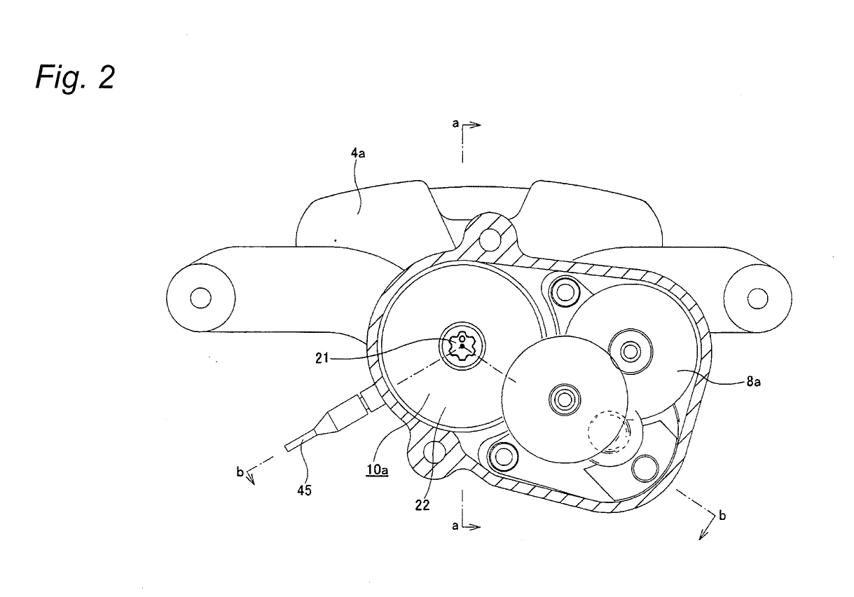

FIG. 1 to 3 show a first embodiment of the invention. In addition, the invention including the present embodiment relates to a structure for being constructed so that a measuring unit including a thrust generation mechanism 7a driven by an electric motor 8a and an axial force sensor 18 to which prestress is applied is easily incorporated into a caliper 4a. This caliper 4a is supported so as to enable axial displacement with respect to a support member (not shown) like a disc brake of a conventionally widely known floating caliper type including a hydraulic type. At the time of braking, the thrust generation mechanism 7a extends and both inner and outer pads 2, 3 are pushed on both side surfaces of a rotor 1. Also, in each of the embodiments of the invention, the thrust generation mechanism 7a is not limited to a structure of combining a ball lamp mechanism 19 with a feed screw mechanism 12 as shown in the drawings, and various mechanical thrust generation mechanisms for converting a force of a rotational direction into an axial force while increasing the force of the rotational direction, for example, a cam roller mechanism or a feed screw mechanism can be adopted.

In the embodiment, the thrust generation mechanism 7a is constructed and a proximal end of a driving spindle 21 whose distal half part (outer side half part) is screwed into a screw hole 20 bored in the center of a driving side rotor 13 is splined to the center of a reduction gear wheel 22 constructing a reducer 10a. An outward flange-shaped flange part 23 is formed in the axial middle of the driving spindle 21. An inner side surface of the flange part 23 is borne on thrust rolling bearings 24. The thrust rolling bearings 24 rotatably support the driving spindle 21 while bearing a thrust load which is applied to the driving spindle 21 and is turned to the inner side.

The flange part 23 and the thrust rolling bearings 24 are accommodated inside a case unit 26 together with the axial force sensor 18 and an elastic member 25 such as a corrugated leaf spring, a compression coil spring or rubber elastically deformable in an axial direction. This case unit 26 is formed by combining an inner case 27 and an outer case 28. This case unit 26 is formed by combining the inner case 27 and the outer case 28 in an inseparable state so as to enable slight relative displacement in the axial direction.

The inner case 27 includes a circular ring-shaped bottom plate part 30 having a circular through hole 29 in the center, and a cylindrical fixing side peripheral wall part 31 extending from the outer peripheral edge of the bottom plate part 30 toward the outer side. An extraction hole 33 for exposing the end of a connector 32 for extracting a measured signal of the axial force sensor 18 is formed in a position of one place in a circumferential direction of the proximal near half portion (inner near portion) of this fixing side peripheral wall part 31. Engaging holes 34, 34 long in the axial direction are formed in plural places (for example, positions of two to three places equally spaced in the circumferential direction) in the circumferential direction of the distal near half portion (outer near portion) of the fixing side peripheral wall part 31. In addition, as the structure for exposing the end of the connector 32, a notch opened in the distal edge (outer side edge) of the fixing side peripheral wall part 31 may be used instead of the extraction hole 33. However, in the case, a circumferential phase between this notch and each of the engaging holes 34, 34 is shifted (the notch is provided between the mutual engaging holes 34, 34 adjacent in the circumferential direction).

On the other hand, the outer case 28 includes a circular ring-shaped bottom plate part 36 having a circular through hole 35 in the center, and a cylindrical displacement side peripheral wall part 37 extending from the outer peripheral edge of the bottom plate part 36 toward the inner side. Then, tongue pieces projecting to the inner side are formed in the portions aligned with each of the engaging holes 34, 34 in positions of plural places in a circumferential direction of the distal edge (inner side edge) of this displacement side peripheral wall part 37. In a state of constructing the case unit 26 by combining both the inner side and outer side cases 27, 28, each of the tongue pieces is folded to the radial inside of this case unit 26 to form engaging pieces 38, 38, and each of these engaging pieces 38, 38 is engaged with each of the engaging holes 34, 34 so as to enable axial displacement. In this state, an axial dimension of the case unit 26 can expand and contract in the range capable of displacing each of the engaging pieces 38, 38 inside each of these engaging holes 34, 34.

Also, in plural places (for example, positions of two to three places equally spaced in the circumferential direction) in the circumferential direction of the displacement side peripheral wall part 37, locking pieces 39, 39 are respectively projected and formed in a state of projecting from an outer peripheral surface of this displacement side peripheral wall part 37 to the radial outside of the case unit 26. Each of these locking pieces 39, 39 is respectively formed by bending and raising a part of a metal plate constructing the displacement side peripheral wall part 37 of the outer case 28 to the radial outside of this outer case 28. The outside diameter side portions of the locking pieces 39, 39 are inclined in a direction in which the amount of projection from the outer peripheral surface of the displacement side peripheral wall part 37 becomes large as the position is near to the outer side so that the outer side ends of outside diameter side portions of the locking pieces 39, 39 are formed in locking edges for engaging with locking recesses 40 described below in the respective locking pieces 39, 39.

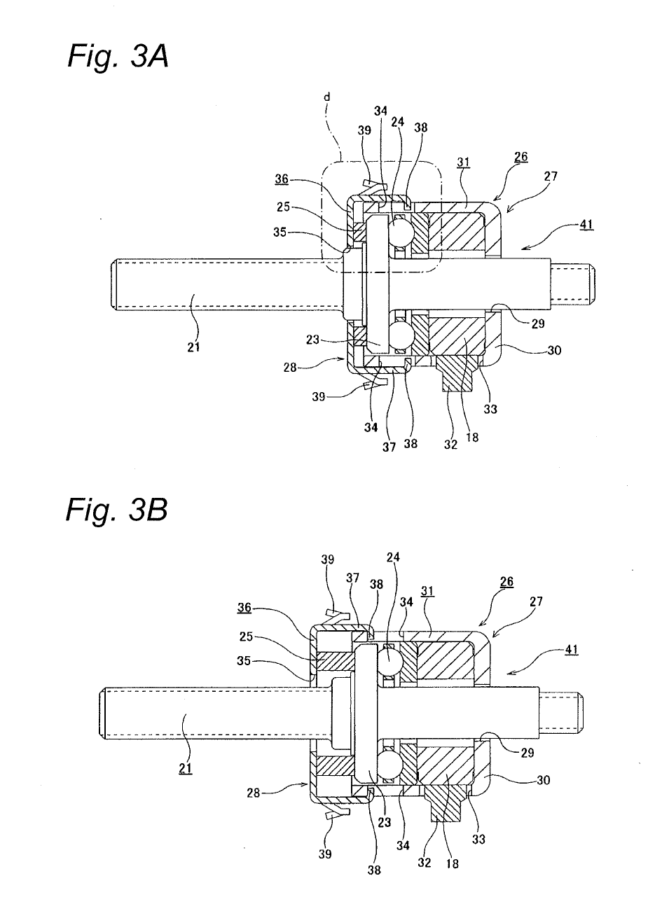

The flange part 23 formed in the middle of the driving spindle 21, the axial force sensor 18, the thrust rolling bearings 24 and the elastic member 25 are incorporated into such a case unit 26. In this incorporation work, after the axial force sensor 18 is first inserted into the back of the inner case 27, the driving spindle 21, the thrust rolling bearings 24 and the elastic member 25 are inserted into the inner case 27. Further, the distal end (inner side end) of the displacement side peripheral wall part 37 of the outer case 28 is externally fitted to the front end (outer side end) of the fixing side peripheral wall part 31 of the inner case 27 and each of the engaging pieces 38, 38 are further engaged with each of the engaging holes 34, 34. In this state, an axial force measuring unit 41 in which each of the members or the parts 21, 23, 18, 24, 25 is incorporated (subassembled) into the case unit 26 is obtained as shown in FIG. 3B. In addition, in this state, sufficient prestress is not yet applied to the axial force sensor 18 in order to ensure measurement accuracy.

The axial force measuring unit 41 is incorporated into the back end (inner side end) of cylinder space 6a provided in the inner side portion of the caliper 4a as shown in FIG. 1. An inside diameter of the back end of this cylinder space 6a is formed in substantially the same diameter as an outside diameter of the fixing side peripheral wall part 31 of the inner case 27, and the inner case 27 is held in the back end of this cylinder space 6a without backlash. However, in the portion aligned with the end of the connector 32 in this back end, a recessed groove 43 opened to the outer side and the inside diameter side of the cylinder space 6a is formed to prevent interference with the end of the connector 32. Also, the locking recess 40 is formed over the whole periphery in the portion near to the back end of the middle of the cylinder space 6a. The outer side end of this locking recess 40 forms a step surface 42 present in a direction perpendicular to the central axis of the cylinder space 6a.

When the axial force measuring unit 41 is incorporated into the back end of the cylinder space 6a, the case unit 26 is pushed into the cylinder space 6a while compressing the elastic member 25 in the axial direction. With this push work, each of the locking pieces 39, 39 is elastically deformed to the radial inside of the case 26 and passes through the outer side to the middle of the cylinder space 6a. Then, the inner case 27 is internally fitted to the back end of the cylinder space 6a and also, until each of the locking pieces 39, 39 is positioned in the inside diameter side of the locking recess 40, the outer case 28 is pushed into the cylinder space 6a. Then, each of the locking pieces 39, 39 elastically projects from the outer peripheral surface of the displacement side peripheral wall part 37 and enters the inside of the locking recess 40. When a force by which the case unit 26 is pushed into the cylinder space 6a is released in this state, each of the distal edge of the locking pieces 39, 39 abuts on the step surface 42 by an elastic force of the elastic member 25, and a situation in which the outer case 28 is displaced in a direction (outer side) of coming out of the cylinder space 6a is eliminated. Also, in this state, sufficient prestress becomes applied to the axial force sensor 18 in order to ensure measurement accuracy. Hence, a plug 46 provided in the end of a harness 45 is inserted into the cylinder space 6a through a connection hole 44 formed in the caliper 4a and this plug 46 is connected to the connector 32 and a measured signal of the axial force sensor 18 can be extracted.

Work of assembling the axial force measuring unit 41 can be done in wide space of the outside of the cylinder space 6a, and work of incorporating this axial force measuring unit 41 into this cylinder space 6a can easily be done by only pushing the axial force measuring unit 41 into the cylinder space 6a after a phase between the connector 32 and the recessed groove 43 is simply matched. Further, work of incorporating the driving side rotor 13 constructing the ball lamp mechanism 19 into the outer side of this axial force measuring unit 41 can easily be done by screwing the driving side rotor 13 into the outer side portion of the driving spindle 21 while rotating the portion projecting from the inner side end surface of the caliper 4a in the inner side end of the driving spindle 21. Also, work of incorporating other members can easily be done by inserting other members into the cylinder space 6a from an outer side opening. Then, in a state of incorporating this axial force measuring unit 41 into the cylinder space 6a, proper prestress becomes applied to the axial force sensor 18, and a relation between a measured signal of this axial force sensor 18 and an axial force applied to this axial force sensor 18 with braking can be made substantially linear. As a result, the axial force can be obtained with sufficient accuracy even when a configuration of a calculator for processing this measured signal is simplified.

### Second Embodiment

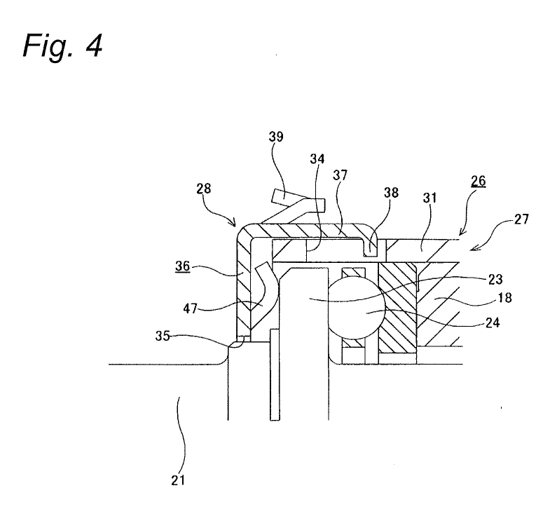

FIG. 4 shows a second embodiment of the invention. In the case of the present embodiment, elastic pieces 47 projecting to the inner side are respectively formed in plural places in a circumferential direction of a bottom plate part 36 of an outer case 28, and an outer side surface of a flange part 23 formed in the middle of a driving spindle 21 is pressed by each of these elastic pieces 47. The elastic member 25 (see FIGS. 1 and 3) incorporated in the first embodiment described above is omitted, and the flange part 23 is elastically pressed toward an axial force sensor 18 (see FIGS. 1 and 3) by each of the elastic pieces 47. Since configurations and action of the other portions are similar to those of the first embodiment described above, illustration and explanation as to the same portions are omitted.

### Third Embodiment

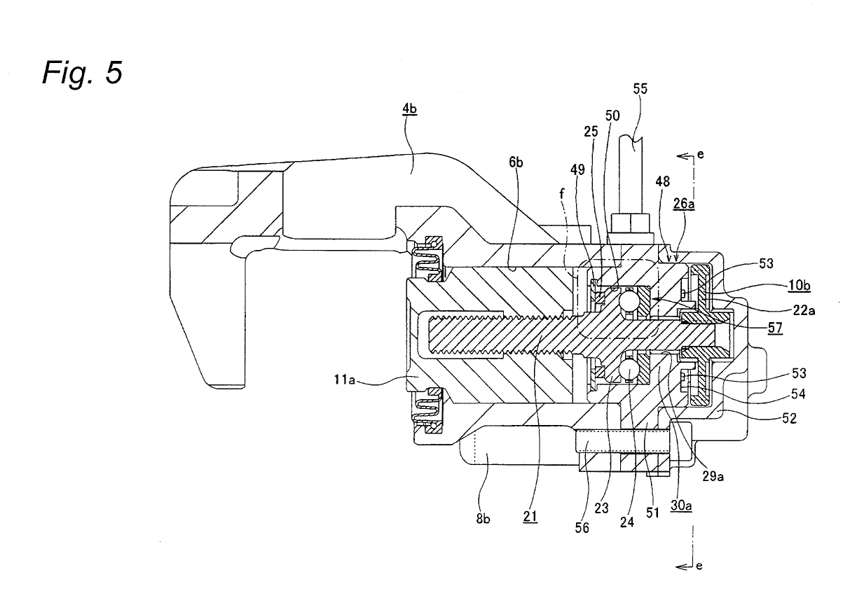

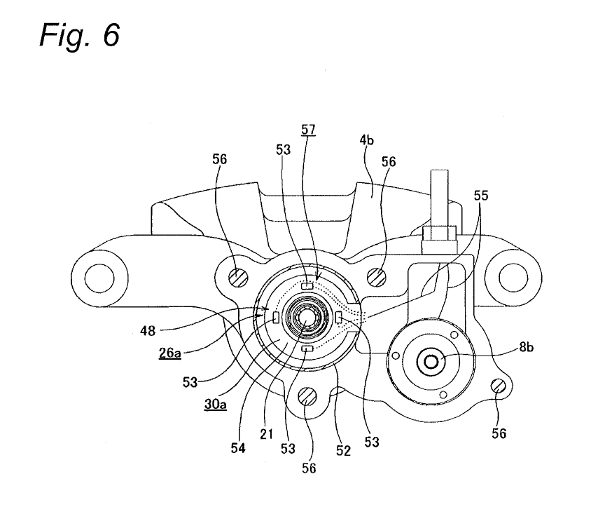

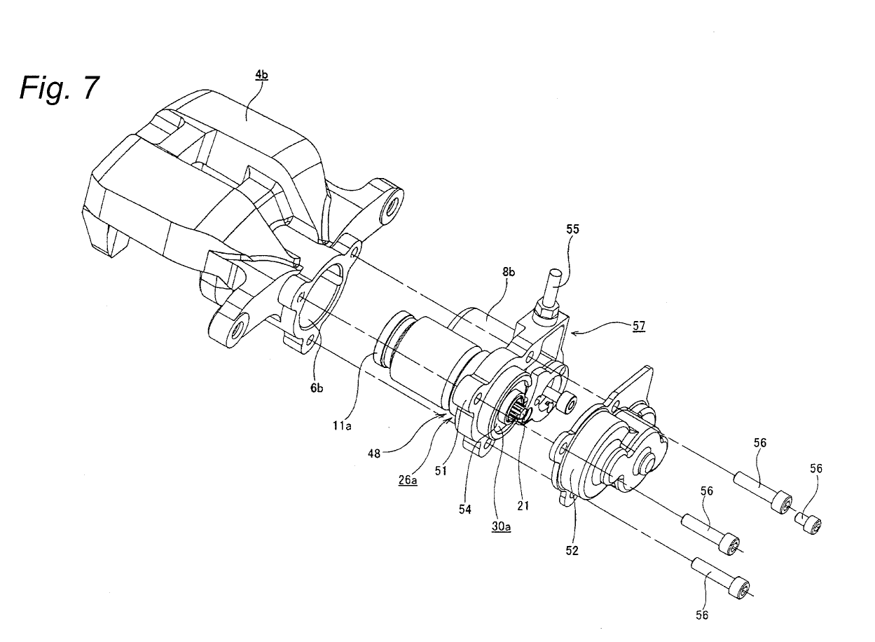

FIG. 5 to 7 show a third embodiment of the invention. In the case of the present embodiment, a case body 48 and a snap ring 49 correspond to an inner case and an outer case constructing a case unit 26a for storing thrust rolling bearings 24 and a flange part 23. The case body 48 which is the inner case of them is formed integrally to an attachment protrusion 51, and includes a holding recess 50 which is opened to the outer side and can accommodate an elastic member 25 in addition to the flange part 23 and the thrust rolling bearings 24. A driving spindle 21 in which the middle is provided with the flange part 23 is projected to the outside of this case body 48 through a through hole 29a bored in the middle of a bottom plate part 30a of the case body 48, and is splined to a reduction gear wheel 22a of a reducer 10b. Also, the attachment protrusion 51 formed on an outer peripheral surface of the case body 48 is coupled and fixed by plural bolts 56, 56 to the inner side end of a caliper 4b together with a reducer case 52 for storing the reducer 10b.

The outer peripheral edge of the snap ring 49 is locked in the outer side end of an inner peripheral surface of the holding recess 50 in the case body 48 as described above. Then, in order from the inner side (side of the back end surface of this holding recess 50), the thrust rolling bearings 24, the flange part 23 and the elastic member 25 are formed between the back end surface of this holding recess 50 and an inner side surface of this snap ring 49. The snap ring 49 is locked in the inner peripheral surface of the holding recess 50 in a state of compressing this elastic member 25 in an axial direction by a proper amount (the extent to which the attach portions of strain sensors 53, 53 described below in the case body 48 are elastically deformed properly).

Further, an annular recess 54 is formed in the radial middle of an inner side end surface of the case body 48 over the whole periphery. Then, each of the strain sensors 53, 53 is attached to the bottom of this annular recess 54 by adhesion etc., and strain of the inner side end of the case body 48 can be measured. In an illustrated example, each of the strain sensors 53, 53 is installed in positions of four places equally spaced in a circumferential direction of the bottom of the annular recess 54. Then, a measured signal of each of the strain sensors 53, 53 extracted by harnesses 55, 55 is processed by a bridge circuit (not shown) etc. and strain of the inner side end of the case body 48 is obtained and further, an axial force applied to the driving spindle 21 is obtained from this strain. Since prestress is applied to the inner side end of the case body 48 by the elastic member 25 in order to measure this strain, a relation between the measured signal of each of the strain sensors 53, 53 and the axial force can be made substantially linear, and the axial force can be obtained accurately even when a configuration of a calculator for processing this measured signal is simplified like the case of the first embodiment described above.

Also, in the case of the present embodiment, by the snap ring 49 with respect to the case body 48, the thrust rolling bearings 24, the flange part 23 and the elastic member 25 are supported and also a piston member 11a is supported through the driving spindle 21 and further an electric motor 8b is supported and thereby, a thrust generation unit 57 is constructed. Since assembly work of this thrust generation unit 57 can be done in a wide place independently of cylinder space 6b of the caliper 4b, it is easy to do the work. Further, work of incorporating the thrust generation unit 57 into the caliper 4b can easily be done by abutting the attachment protrusion 51 on an inner side end surface of the caliper 4b while inserting the piston member 11a into the cylinder space 6b and further coupling and fixing the attachment protrusion 51 to the caliper 4b together with the reducer case 52 by each of the bolts 56, 56. In addition, in the illustrated example, as a thrust generation mechanism for converting rotational motion of the driving spindle 21 into linear motion of the piston member 11a, a simple feed screw mechanism is used, but in a structure of this thrust generation mechanism, various structures known conventionally including the structure shown in the first embodiment described above can be adopted.

### Fourth Embodiment

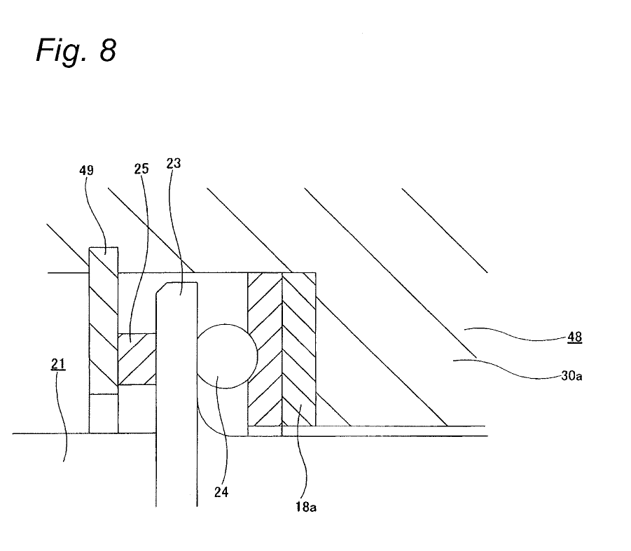

FIG. 8 shows a fourth embodiment of the invention. In the case of the present example, an axial force sensor 18a for measuring a force in an axial direction by being compressed is pinched between thrust rolling bearings 24 and an outer side surface of a bottom plate part 30a of a case body 48. Then, it is constructed so that an axial force applied to a driving spindle 21 at the time of braking can be measured by the axial force sensor 18a. Since configurations and action of the other portions are similar to those of the third embodiment described above, illustration and explanation as to the same portions are omitted.

### INDUSTRIAL APPLICABILITY

The invention can be used in an electric disc brake.

### REFERENCE SIGNS LIST

1 ROTOR
2 INNER PAD
3 OUTER PAD
4, 4a, 4b CALIPER
5 CALIPER CLAW
6, 6a, 6b CYLINDER SPACE
7, 7a THRUST GENERATION MECHANISM
8, 8a, 8b ELECTRIC MOTOR
9 OUTPUT SHAFT
10, 10a, 10b REDUCER
11, 11a PISTON MEMBER
12 FEED SCREW MECHANISM
13 DRIVING SIDE ROTOR
14 DRIVING SIDE LAMP GROOVE
15 DRIVEN SIDE STATOR
16 DRIVEN SIDE LAMP GROOVE
17 BALL
18, 18a AXIAL FORCE SENSOR
19 BALL LAMP MECHANISM
20 SCREW HOLE
21 DRIVING SPINDLE
22, 22a REDUCTION GEAR WHEEL
23 FLANGE PART
24 THRUST ROLLING BEARING
25 ELASTIC MEMBER
26, 26a CASE UNIT
27 INNER CASE
28 OUTER CASE
29, 29a THROUGH HOLE
30, 30a BOTTOM PLATE PART
31 FIXING SIDE PERIPHERAL WALL PART
32 CONNECTOR
33 EXTRACTION HOLE
34 ENGAGING HOLE
35 THROUGH HOLE
36 BOTTOM PLATE PART
37 DISPLACEMENT SIDE PERIPHERAL WALL PART
38 ENGAGING PIECE
39 LOCKING PIECE
40 LOCKING RECESS
41 AXIAL FORCE MEASURING UNIT
42 STEP SURFACE
43 RECESSED GROOVE
44 CONNECTION HOLE
45 HARNESS
46 PLUG
47 ELASTIC PIECE
48 CASE BODY
49 SNAP RING
50 HOLDING RECESS
51 ATTACHMENT PROTRUSION
52 REDUCER CASE
53 STRAIN SENSOR
54 ANNULAR RECESS
55 HARNESS
56 BOLT
57 THRUST GENERATION UNIT

1. An electric disc brake apparatus comprising:
a rotor configured to rotate with a wheel;
a support member supported in a vehicle body;
an outer pad, arranged in an outer side in an axial direction of the rotor, and supported by the support member so as to be displaced in the axial direction;
an inner pad, arranged in an inner side in the axial direction, and supported by the support member so as to be displaced in the axial direction;
a caliper, including a caliper claw provided in an outer side end of the axial direction and opposed to an outer side surface of the outer pad, and an accommodating space formed inside an inner side portion of the axial direction, the caliper being supported so as to be displaced in the axial direction with respect to the support member; and
an actuator, arranged in the accommodating space, and configured to press the inner pad toward an inner side surface of the rotor,
wherein the actuator includes:
an electric motor;
a force-multiplication mechanism, configured to convert a rotational driving force of the electric motor into an axial thrust force and to transmit the force to the inner pad; and
a sensor, configured to measure a pressing force applied from the force-multiplication mechanism to the inner pad,
wherein a rotating shaft which is rotated by the electric motor and performs as an input part of the force-multiplication mechanism is provided with a flange part projecting outwardly in a radial direction from the rotating shaft,
wherein a thrust bearing is provided between the sensor and an inner side surface of the flange part,
wherein the thrust bearing and the flange part are accommodated in a case unit, and
wherein the case unit includes an inner case provided in a portion including an inner side from the thrust bearings, and an outer case provided in a portion including an outer side from the flange part and is coupled with this inner case in an inseparable state, and
wherein an elastic member is provided between an inner side surface of the outer case and an outer side surface of the flange part, and
wherein the elastic member urges the thrust bearing to a side of the inner case in which the sensor is installed.

2. The electric disc brake apparatus as claimed in claim 1, wherein
the case unit is divided into two pieces in the axial direction, one piece of the divided case unit positioned in an inner side is the inner case, and the other piece of the divided case unit positioned in an outer side is the outer case,
the sensor, the thrust bearings, the flange part and the elastic member are accommodated in the case unit in a state of urging the sensor in the axial direction by the elastic member, so that the thrust bearing is arranged in an outer side of the sensor, the flange part is arranged in an outer side of the thrust bearing, and the elastic member is arranged in an outer side of the flange part,
the outer case is provided with a locking piece elastically projecting outwardly in the radial direction of the outer case from an outer peripheral surface of the radial direction of the outer case,
an inner peripheral surface of the radial direction of the accommodating space is provided with a locking recess, and
the locking piece engages with the locking recess, and the sensor, the thrust bearing, the flange part and the elastic member are held in the accommodating space through the case unit.

3. The electric disc brake apparatus as claimed in claim 2, wherein
the elastic member having an axial elastic force is attached to an outer side surface of the flange part, and
the sensor, the thrust bearing and the flange part are accommodated in the case unit in a state where the elastic member is elastically compressed in the axial direction.

4. The electric disc brake apparatus as claimed in claim 2, wherein
one of the inner case and the outer case which is arranged in a side opposite to the sensor with the flange part pinched is provided with an elastic piece as the elastic member, and
the elastic piece urges the flange part toward the sensor.

5. The electric disc brake apparatus as claimed in claim 2, wherein
the inner case includes a bottom plate part having a central hole into which the rotating shaft is rotatably inserted, and a cylindrical part folded in a direction near to the outer case from a radial peripheral edge of the bottom plate part,
the outer case includes a bottom plate part having a central hole into which the rotating shaft is rotatably inserted, and a cylindrical part folded in a direction near to the inner case from a radial peripheral edge of the bottom plate part,
the cylindrical part of the outer case is externally fitted to the cylindrical part of the inner case,
a distal edge of an inner side of the cylindrical part of the outer case is provided with a protrusion piece folded inwardly in the radial direction,
an engaging hole is formed in a part of the cylindrical part of the inner case, and
the protrusion piece is inserted into the engaging hole, and the inner case and the outer case are coupled in an inseparable state so as to relatively move in the axial direction.

6. The electric disc brake apparatus as claimed in claim 1, wherein
the outer case is made of a case body including a holding recess which rotatably accommodates the flange part and is opened to an outer side,
the inner case is made of a snap ring locked in an opening side end of the holding recess,
the thrust bearing, the flange part and the elastic member are accommodated in the case unit made of the case body and the snap ring in a state where the sensor is urged in the axial direction by the elastic member so that the flange part is arranged in an outer side of the thrust bearing and the elastic member is arranged in an outer side of the flange part,
the sensor is incorporated into the case body, and
the case body is fixed to an inner side end of the caliper.

7. The electric disc brake apparatus as claimed in claim 6, wherein
the sensor is made of a strain sensor which is attached to a surface of the case body and measures an urging force by the elastic member based on strain of the case body.

8. An electric disc brake apparatus as claimed in claim 6, wherein
the sensor is pinched between the thrust rolling bearings and the case body.
